(19) United States
(12) Patent Application Publication
(10) Pub. No.: US 2007/0161313 A1
(43) Pub. Date: Jul. 12, 2007

(54) METHOD FOR MANUFACTURING FIELD EMISSION CATHODE

(75) Inventor: TSAI-SHIH TUNG, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,591

(22) Filed: Aug. 28, 2006

(30) Foreign Application Priority Data
Dec. 23, 2005 (CN) 200510121250.1

(51) Int. Cl. H01J 9/04; H01J 9/12; H01J 9/00

(52) U.S. Cl. 445/24; 445/50

(57) ABSTRACT

A method for manufacturing a field emission cathode includes the steps of: providing a substrate (110); forming an aluminum layer (130) on the substrate; anodizing the aluminum layer thereby forming a porous aluminum oxide layer (132) on the aluminum layer, the porous aluminum oxide layer comprising a plurality of holes (134); removing portions of the aluminum oxide layer in the plurality of holes so as to expose corresponding portions of the underlying aluminum layer in the plurality of holes; and forming a plurality of carbon nanotubes (490) on the exposed portions of the aluminum layer in the plurality of holes by electrophoresis deposition process.

### FIELD OF THE INVENTION

The present invention generally relates to methods for manufacturing field emission cathodes. Specifically, the present invention relates to a method for manufacturing field emission cathode with carbon nanotubes.

### DESCRIPTION OF RELATED ART

Carbon nanotubes (CNTs) produced by arc discharge between graphite rods were first discovered and reported in an article by Sumio Iijima entitled “Helical Microtubules of Graphitic Carbon” (Nature, Vol. 354, Nov. 7, 1991, pp. 56-58).

Carbon nanotubes are electrically conductive along their length, are chemically stable, and can have very small diameters (much less than 100 nanometers) and large aspect ratios (length/diameter). Due to these and other properties, it has been suggested that carbon nanotubes can play an important role in fields such as microscopic electronics, field emission devices, thermal interface materials, etc.

At present, methods for manufacturing CNTs mainly include arc-discharge methods, pulsed laser vaporization methods, and chemical vapor deposition (CVD) methods. When CNTs are used as emitters of field emission devices, they are not grown directly from a substrate of the field emission devices. Generally, the CNTs are first applied in a slurry of thermoplastic polymer randomly oriented in a continuous process, and then the slurry is printed on the substrate using a thick-film screen-printing process. However, the CNTs provided by this process are apt to be twisted and buried in the slurry so that a top layer of the slurry needs to be striped to expose the CNTs. This striping process may cause damage to the CNTs. If such CNTs are employed as electron emitters of a field emission cathode, an electron emissivity, stability, and emission life of the field emission cathode may be reduced as a result.

What is needed, therefore, is to provide a method for manufacturing a field emission cathode with carbon nanotubes, which can overcome the above-mentioned shortcomings.

### SUMMARY OF THE INVENTION

In a preferred embodiment, a method for manufacturing a field emission cathode includes the steps of: providing a substrate; forming an aluminum layer on the substrate; anodizing the aluminum layer thereby forming a porous aluminum oxide layer on the aluminum layer, the porous aluminum oxide layer comprising a plurality of holes; removing portions of the aluminum oxide layer in the plurality of holes so as to expose corresponding portions of the underlying aluminum layer in the plurality of holes; and forming a plurality of carbon nanotubes on the exposed portions of the aluminum layer in the plurality of holes using an electrophoresis deposition process.

Advantages and novel features will become more apparent from the following detailed description of the present method, when taken in conjunction with the accompanying drawings.

### BRIEF DESCRIPTION OF THE DRAWINGS

Many aspects of the present method can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views.

FIG. 1 is a flow chart of a method for manufacturing a field emission cathode in accordance with a preferred embodiment;

FIGS. 2A to 2D are schematic views illustrating successive stages of the method for manufacturing a field emission cathode of FIG. 1; and

FIGS. 3A to 3B are schematic views illustrating successive stage of a procedure for depositing carbon nanotubes using an electrophoresis deposition process.

Corresponding reference characters indicate corresponding parts throughout the drawings. The exemplifications set out herein illustrate at least one preferred embodiment of the present method, in one form, and such exemplifications are not to be construed as limiting the scope of the invention in any manner.

### DETAILED DESCRIPTION OF THE INVENTION

Reference will now be made to the drawings to describe preferred embodiments of the present method, in detail.

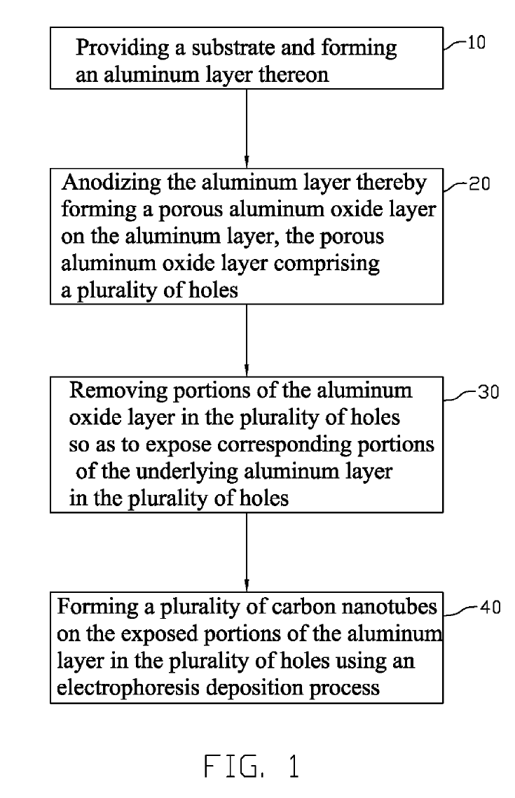

Referring to FIG. 1, successive steps of a method for manufacturing a field emission cathode, in accordance with a preferred embodiment, are shown. The method includes the steps of:
(10) providing a substrate and forming an aluminum layer thereon;
(20) anodizing the aluminum layer thereby forming a porous aluminum oxide layer on the aluminum layer, the porous aluminum oxide layer comprising a plurality of holes;
(30) removing portions of the aluminum oxide layer in the plurality of holes so as to expose corresponding portions of the underlying aluminum layer in the plurality of holes; and
(40) forming a plurality of carbon nanotubes on the exposed portions of the aluminum layer in the plurality of holes using an electrophoresis deposition process.

In step (10), a material of the substrate 110 is a glass substrate or an electrically conductive substrate, for example, an electrically conductive glass substrate of indium tin oxide or a glass substrate coated with silver. If a glass substrate is provided, an electrically conductive layer 120 is generally formed on the substrate 110 before forming the aluminum layer 130.

The aluminum layer 130 is formed on the substrate 110 using a thermal evaporating process, a sputtering process or a thermal chemical vapor deposition process. In the preferred embodiment, the aluminum layer 130 is deposited on the substrate 110 through the thermal chemical vapor deposition process.

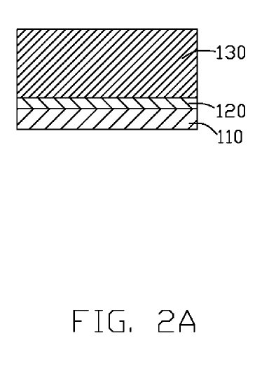

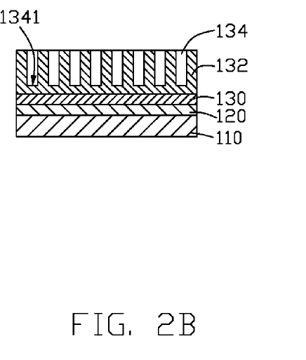

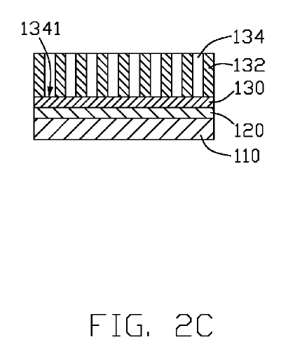

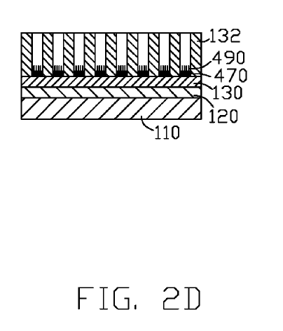

Referring to FIG. 2A, in step (20), since the aluminum layer 130 is deposited on the substrate, the anodizing step is an anodizing process for aluminum. In the process for anodizing aluminum, aluminum ions are generated from the aluminum layer 130, and react with anions containing oxygen in an electrolyte as in a following chemical reaction equation:
2Al³⁺+3R²⁻+2H₂O→Al₂O₃+3H₂R
wherein R represents a negative bivalent acid radical containing oxygen or oxygenic anion. After the reaction, a porous aluminum oxide layer 132 with a plurality of holes 134 therein is formed on the aluminum layer 130, as shown in FIG. 2B. As the process of anodizing continues, the aluminum oxide layer 132 becomes thicker as aluminous ions react with R²⁻ near an interface between the aluminum layer 130 and the electrolyte. A shape and a depth of the hole 134 are controlled by reactive conditions, such as type and concentration of the acid, an etching time, an electric current, etc.

Referring to FIG. 2C, in step (30), after the anodizing step, the aluminum oxide layer 132 with the plurality of holes 134 therein is formed on the aluminum layer 130. An acid solution is used to remove portions of the aluminum oxide layer 132 in bottoms 1341 of the plurality of holes 134 so as to expose corresponding portions of the underlying aluminum layer 130 in the plurality of holes 134. The acid solution should preferably be an oxalic acid. When the portions of the aluminum oxide layer 132 in the plurality of holes 134 are removed, walls of the plurality of holes 134 may be removed too. However, since a thickness of the walls is greater than that of the portions of the aluminum oxide layer 132 in the holes 134, when the portions of the aluminum oxide layer 132 in the holes 134 are removed to expose corresponding portions of the underlying aluminum layer 130 in the plurality of holes 134, portions of the walls with the same thickness as that of the removed portions of the aluminum oxide layer 132 in the holes 134 are removed. Therefore, each of the plurality of holes 134 becomes larger.

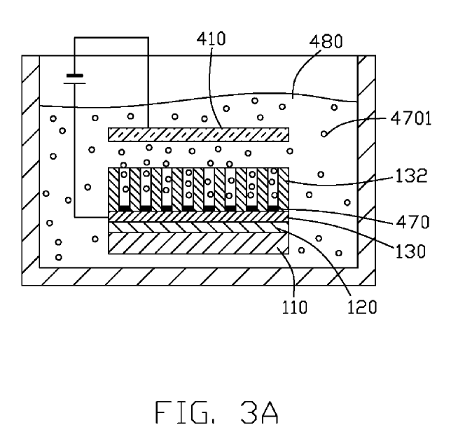

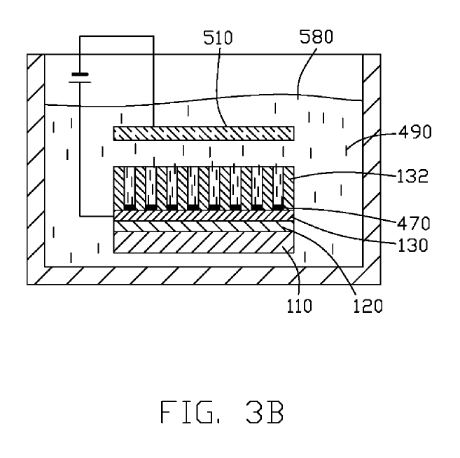

Referring to FIGS. 2D and 3A, in step (40), firstly, a binder 470 is deposited on the aluminum layer 130 in the plurality of holes 134 by an electrophoresis deposition process in a reservoir filled with an aqueous solution 480. The aqueous solution 480 contains particles 4701 of magnesium nitrate [Mg(NO₃)₂]. An electrical field is applied between an electrode 410 and the aluminum layer 130 so that a magnesium hydroxide [Mg(OH)₂] layer acting as the binder 470 is formed on the aluminum layer 130 in the plurality of holes 134 as follows:
Mg(NO₃)⁺+2OH^{-→}Mg(OH)₂+NO₃⁻

Referring to FIGS. 2d and 3b, secondly, carbon nanotubes 490 are attached on the binder 470 by another electrophoresis deposition process in another reservoir filled with an alcoholic solution 580. The alcoholic solution 580 contains carbon nanotubes 490. An electrical field is applied between an electrode 510 and the aluminum layer 130 so that carbon nanotubes 490 are attached on the binder 470. A thickness of attached carbon nanotubes 490 is controlled by electrophoresis parameters, such as a voltage of the electrical field, concentration of the alcoholic solution 580 and time length of electrophoresis deposition. When a desirable thickness of attached carbon nanotubes 490 is achieved, the electrophoresis deposition process is stopped and the substrate 110 is heated to a temperature in a range from 100 to 200 degrees centigrade so as to sinter the binder 470 and carbon nanotubes 490.

Since the carbon nanotubes 490 are formed on the substrate 110 in the field emission cathode by an electrophoresis process, carbon nanotubes 490 may be almost perpendicular to the substrate 110 and vertically-aligned. Therefore a field emission performance of the field emission cathode is enhanced.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A method for manufacturing a field emission cathode, the method comprising the steps of:
providing a substrate;
forming an aluminum layer on the substrate;
anodizing the aluminum layer thereby forming a porous aluminum oxide layer on the aluminum layer, the porous aluminum oxide layer comprising a plurality of holes;
removing portions of the aluminum oxide layer in the plurality of holes so as to expose corresponding portions of the underlying aluminum layer in the plurality of holes; and
forming a plurality of carbon nanotubes on the exposed portions of the aluminum layer in the plurality of holes by an electrophoresis deposition process.

2. The method as claimed in claim 1, wherein the substrate is an electrically conductive substrate.

3. The method as claimed in claim 2, wherein the electrically conductive substrate is a glass substrate coated with silver or a glass of indium tin oxide.

4. The method as claimed in claim 1, wherein the step of forming the aluminum layer is performed by a process selected from the group consisting of a thermal evaporating process, a sputtering process, and a thermal chemical vapor deposition process.

5. The method as claimed in claim 1, wherein the portions of the aluminum oxide layer in the plurality of holes is removed by etching using an acid solution.

6. The method as claimed in claim 1, further comprising a step of forming a binder on the aluminum layer in the plurality of holes prior to the step of forming the carbon nanotubes on the aluminum layer in the plurality of holes.

7. The method as claimed in claim 6, wherein the binder is magnesium hydroxide.

8. The method as claimed in claim 6, wherein the carbon nanotubes are attached to the binder.

9. The method as claimed in claim 6, further comprising a step of heating the substrate after the step of forming the carbon nanotubes on the aluminum layer in the plurality of holes.
